(19) United States
(12) Patent Application Publication
(10) Pub. No.: US 2026/0319341 A1
(43) Pub. Date: Oct. 15, 2026

(54) INTERCHANGEABLE LENS AND IMAGING DEVICE

(71) Applicant: SONY GROUP CORPORATION, TOKYO (JP)

(72) Inventors: TSUYOSHI MORI, TOKYO (JP); TSUTOMU NAITOU, TOKYO (JP)

(21) Appl. No.: 19/476,210

(22) PCT Filed: Apr. 8, 2024
(86) PCT No.: PCT/JP2024/014283

§ 371 Date: Oct. 17, 2025

(30) Foreign Application Priority Data
Apr. 28, 2023 (JP) 2023-074234

(51) Int. Cl. G03B 17/14

(52) U.S. Cl. CPC G03B 17/14

(57) ABSTRACT

An interchangeable lens includes: a pair of first guide shafts that are held by a shaft holding portion of a moving body and are arranged in a direction orthogonal to an optical axis direction; one first rolling ball that is rolled with respect to a pair of first guide shafts when the moving body moves in the optical axis direction; a pair of second guide shafts that are held by the shaft holding portion and are arranged in a direction orthogonal to the optical axis direction; a pair of third guide shafts that are located on the opposite side of the first guide shaft with the second guide shaft interposed therebetween and are arranged in a direction orthogonal to the optical axis direction; a plurality of second rolling balls rolled with respect to the pair of second guide shafts and the pair of third guide shafts; and a biasing mechanism that biases the first rolling ball in a direction of pressing the first rolling ball against the first guide shaft. A biasing force applied to the first rolling ball by the biasing mechanism is distributed to the plurality of second rolling balls via the first guide shaft and the second guide shaft.

### TECHNICAL FIELD

The present technology relates to a technical field of an interchangeable lens detachably attached to a device main body having an imaging element and an imaging device including the interchangeable lens.

### BACKGROUND ART

A structure used for imaging such as various imaging devices like a video camera and a still camera, and an interchangeable lens is provided with an optical system having an optical element such as a lens arranged therein.

Among such structures, there is a structure in which an optical element such as a lens is held by a moving frame to constitute a moving body, and the moving body is moved in an optical axis direction (See, for example, Patent Document 1.). In the moving body, a guide shaft is inserted into each of a plurality of bearing portions, and the moving body is moved in the optical axis direction, whereby focusing or zooming is performed, for example.

### CITATION LIST

### Patent Document

Patent Document 1: Japanese Patent Application Laid-Open No. 2016-145878

### SUMMARY OF THE INVENTION

### Problems to be Solved by the Invention

When focusing or zooming is performed in the imaging device or the interchangeable lens as described above, the moving body is moved in the optical axis direction at a high speed and stopped at a predetermined position, whereby focusing or zooming is performed.

Incidentally, while the moving body is guided by the plurality of guide shafts and moved in the optical axis direction, sufficient followability of minute displacement cannot be secured due to sliding resistance of the bearing portion with respect to the guide shaft, and there is a possibility that high stop position accuracy of the moving body cannot be secured. In addition, there is a possibility that inclination in a so-called tilt direction in which the moving body tilts with respect to the guide shaft occurs due to a minute clearance existing between the bearing portion of the moving body and the guide shaft.

When such sufficient stop position accuracy cannot be secured or inclination in the tilt direction of the moving body occurs, image quality may deteriorate. Therefore, it is desirable to secure a stable operation state of the moving body by securing high stop position accuracy and preventing occurrence of inclination of the moving body as much as possible.

Therefore, an object of the interchangeable lens and the imaging device of the present technology is to ensure a stable operation state of the moving body.

### Solutions to Problems

An interchangeable lens according to the present technology includes: a moving body including a moving frame provided with a shaft holding portion and an optical element held by the moving frame, the moving body being moved in an optical axis direction; a drive source that applies a drive force to the moving body; a pair of first guide shafts that are held by the shaft holding portion, have an axial direction coinciding with the optical axis direction, and are arranged in a direction orthogonal to the optical axis direction; one first rolling ball that is rolled with respect to the pair of first guide shafts when the moving body moves in the optical axis direction; a pair of second guide shafts that are held by the shaft holding portion, have an axial direction coinciding with the optical axis direction, and are arranged in a direction orthogonal to the optical axis direction; a pair of third guide shafts that are located on the opposite side of the first guide shaft with the second guide shaft interposed therebetween, have an axial direction coinciding with the optical axis direction, and are arranged in a direction orthogonal to the optical axis direction; a plurality of second rolling balls located separately in the optical axis direction and rolled with respect to the pair of second guide shafts and the pair of third guide shafts when the moving body moves in the optical axis direction; and a biasing mechanism that biases the first rolling ball in a direction of pressing the first rolling ball against the first guide shaft. A biasing force applied to the first rolling ball by the biasing mechanism is distributed to the plurality of second rolling balls via the first guide shaft and the second guide shaft.

As a result, the first rolling ball is pressed against the first guide shaft by the biasing force of the biasing mechanism, the second guide shaft is pressed against the second rolling ball, and the biasing force is dispersed and applied to the plurality of second rolling balls.

An imaging device according to the present technology includes: a device main body including an imaging element that converts a captured optical image into an electrical signal; an interchangeable lens detachably attached to the device main body; a moving body including a moving frame provided with a shaft holding portion and an optical element held by the moving frame, the moving body being moved in an optical axis direction; a drive source that applies a drive force to the moving body; a pair of first guide shafts that are held by the shaft holding portion, have an axial direction coinciding with the optical axis direction, and are arranged in a direction orthogonal to the optical axis direction; one first rolling ball that is rolled with respect to the pair of first guide shafts when the moving body moves in the optical axis direction; a pair of second guide shafts that are held by the shaft holding portion, have an axial direction coinciding with the optical axis direction, and are arranged in a direction orthogonal to the optical axis direction; a pair of third guide shafts that are located on the opposite side of the first guide shaft with the second guide shaft interposed therebetween, have an axial direction coinciding with the optical axis direction, and are arranged in a direction orthogonal to the optical axis direction; a plurality of second rolling balls located separately in the optical axis direction and rolled with respect to the pair of second guide shafts and the pair of third guide shafts when the moving body moves in the optical axis direction; and a biasing mechanism that biases the first rolling ball in a direction of pressing the first rolling ball against the first guide shaft. A biasing force applied to the first rolling ball by the biasing mechanism is distributed to the plurality of second rolling balls via the first guide shaft and the second guide shaft.

As a result, the first rolling ball is pressed against the first guide shaft by the biasing force of the biasing mechanism, the second guide shaft is pressed against the second rolling ball, and the biasing force is dispersed and applied to the plurality of second rolling balls.

### BRIEF DESCRIPTION OF DRAWINGS

FIG. 1 illustrates an embodiment of an interchangeable lens and an imaging device according to the present technology in conjunction with FIGS. 2 to 10, and is a perspective view of the imaging device.

FIG. 2 is a perspective view illustrating an internal structure of the interchangeable lens.

FIG. 3 is an exploded perspective view illustrating the internal structure of the interchangeable lens.

FIG. 4 is an exploded perspective view illustrating the internal structure of the interchangeable lens as viewed from a direction different from that in FIG. 3.

FIG. 5 is a front view illustrating a part of the internal structure of the interchangeable lens.

FIG. 6 illustrates an operation in the interchangeable lens in conjunction with FIGS. 7 to 9, and is a side view illustrating an initial state.

FIG. 7 is a side view illustrating a state in which a moving body is moved in an optical axis direction.

FIG. 8 is a side view illustrating a state in which a retainer and a first rolling ball are moved to a side approaching a movement restriction portion.

FIG. 9 is a side view illustrating a state in which a reset operation is started and a pressurizing base is pushed up.

FIG. 10 is a block diagram of the imaging device.

### MODE FOR CARRYING OUT THE INVENTION

In the description below, a mode for carrying out the present technology will be described with reference to the accompanying drawings.

In the embodiment described below, an imaging device according to the present technology is applied to a still camera, and an interchangeable lens according to the present technology is applied to an interchangeable lens detachable from a device main body of the still camera.

Note that the application range of the present technology is not limited to the still camera and the interchangeable lens detachable from the device main body of the still camera. The present technology can be widely applied to, for example, various imaging devices incorporated in a video camera and other devices as imaging devices, and interchangeable lenses detachable from device main bodies of these imaging devices.

In the following description, it is assumed that front-rear, upper-lower, and left-right directions are indicated as directions viewed from the image capturing person at the time of imaging with the still camera. Therefore, the object side is the front, and the image plane side is the rear.

Note that the front-rear, upper-lower, and left-right directions below are for the sake of convenience in description, and the implementation of the present technology is not limited to these directions.

### Configuration of Imaging Device

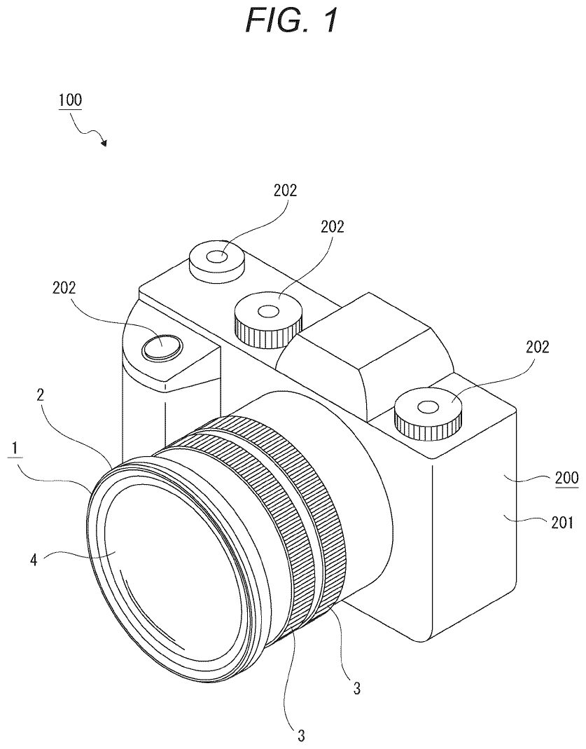

An imaging device 100 includes a device main body 200 and an interchangeable lens 1 (see FIG. 1). Note, however, that the imaging device 100 may be configured of only the device main body 200, for example, like a so-called retractable type in which a lens barrel is pushed in and pulled out.

The device main body 200 is formed by arranging required units inside and outside an outer casing 201.

In the outer casing 201, various operation units 202 are arranged on an upper surface and a rear surface, for example. For example, a power button, a shutter button, a zoom knob, a mode switching knob, and the like are provided as the operation units 202.

A display (display unit) (not illustrated) is arranged on the rear surface of the outer casing 201. A circular opening (not illustrated) is formed on a front surface of the outer casing 201, and a portion around the opening is provided as a mount portion for attaching the interchangeable lens 1. An imaging element (not illustrated) such as a charge coupled device (CCD) or a complementary metal-oxide semiconductor (CMOS) is arranged inside the outer casing 201, and the imaging element is located behind the opening.

### Configuration of Interchangeable Lens

The interchangeable lens 1 is for an interchangeable lens digital camera, for example.

The interchangeable lens 1 includes a lens barrel portion 2, and the lens barrel portion 2 is provided with at least one operation ring 3 for focusing and zooming. When the operation ring 3 is rotationally operated, manual focusing and manual zooming are performed.

In a rear end portion of the lens barrel portion 2, a lens mount (not illustrated) bayonet-coupled to the mount portion of the device main body 200 is provided, for example. The lens barrel portion 2 is provided with an imaging lens 4 arranged on the foremost side.

Note that the configuration of the interchangeable lens 1 is not limited to the above configuration, and may be, for example, a type in which a plurality of lens barrel portions is provided, and one lens barrel portion is pushed in and pulled out with respect to another lens barrel portion to change the overall length.

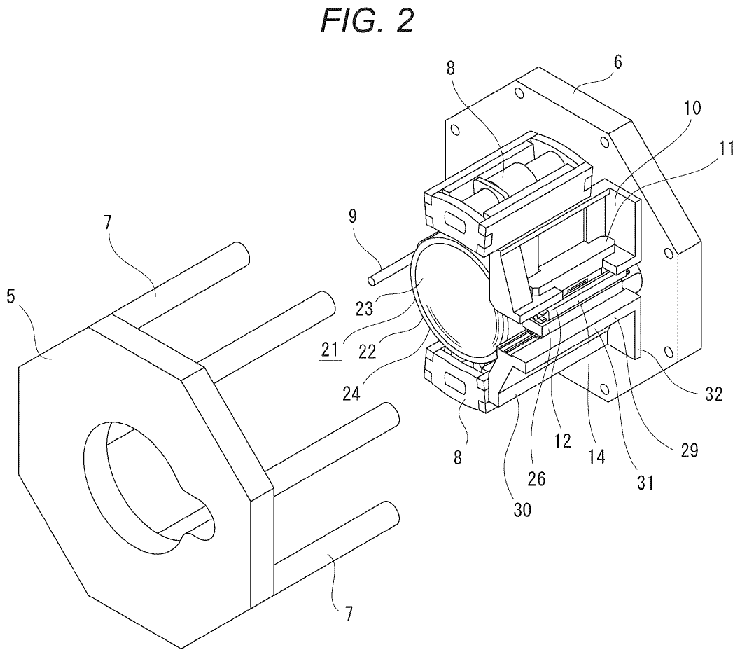

Inside the interchangeable lens 1, a first fixing frame 5 and a second fixing frame 6 are arranged to be separated from each other in the front-rear direction (see FIG. 2). The first fixing frame 5 and the second fixing frame 6 are coupled by a plurality of coupling shafts 7. Outer peripheral portions of the first fixing frame 5 and the second fixing frame 6 are coupled by the plurality of coupling shafts 7, and the plurality of coupling shafts 7 is spaced apart in the circumferential direction.

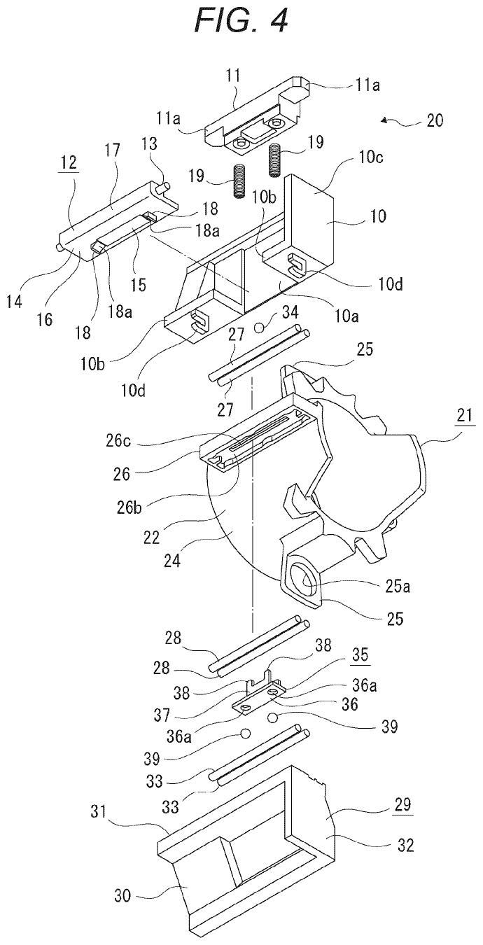

A pair of drive sources 8 are attached to a front surface of the second fixing frame 6 while being vertically separated (see FIGS. 2 to 4). As the drive source 8, for example, an electromagnetic actuator (linear motor) having a magnet, a coil, or a yoke is used, and a rear end portion of the drive source 8 is attached to the second fixing frame 6 and protrudes forward from the second fixing frame 6.

A sub guide shaft 9 is arranged between the first fixing frame 5 and the second fixing frame 6. The sub guide shaft 9 extends in the front-rear direction, and its front and rear end portions are attached to outer peripheral portions of the first fixing frame 5 and the second fixing frame 6, respectively.

A support frame 10 is attached to the front surface of the second fixing frame 6. The support frame 10 protrudes forward from the second fixing frame 6 and is located on the side of the upper drive source 8. The support frame 10 includes a base surface portion 10a facing the left-right direction, two protruding surface portions 10b protruding laterally outward from a lower end portion of the base surface portion 10a, and an attached surface portion 10c protruding laterally outward from a rear end portion of the base surface portion 10a. The two protruding surface portions 10b are provided to be separated from each other in the front-rear direction, and the lower end portion of the attached surface portion 10c is continuous with the rear end portion of the protruding surface portion 10b on the rear side. Each of the support frames 10 is provided with a bearing protrusion 10d protruding downward from the protruding surface portion 10b. The attached surface portion 10c of the support frame 10 is attached to the second fixing frame 6.

A spring holding base 11 is attached to the support frame 10. The spring holding base 11 is formed in a shape in which the front-rear direction is the longitudinal direction, and both front and rear end portions thereof are provided as coupling protrusions 11a protruding forward and backward, respectively. In the spring holding base 11, the coupling protrusions 11a are attached to the protruding surface portions 10b of the support frame 10 from above.

A pressurizing base 12 is rotatably supported by the support frame 10 with a rotation shaft 13 as a fulcrum. The pressurizing base 12 is formed by attaching a pressurizing plate 15 to a plate holder 14.

The plate holder 14 includes a plate-shaped holder portion 16 facing the up-down direction and extending in the front-rear direction, a shaft attachment portion 17 protruding upward from both front and back end portions of one side portion of the holder portion 16, and a pair of movement restriction portions 18 protruding downward from a lower surface of the holder portion 16. The pair of movement restriction portions 18 are provided to be separated from each other in the front-rear direction, and have inclined surfaces 18a inclined so as to be separated from each other toward the lower side.

The rotation shaft 13 is fixed to the shaft attachment portion 17 while extending in the front-rear direction and passing through the two shaft attachment portions 17. Both front and rear end portions of the rotation shaft 13 are supported by the bearing protrusion 10d of the support frame 10. Therefore, the pressurizing base 12 is rotatable with respect to the support frame 10 with the rotation shaft 13 as a fulcrum.

The pressurizing plate 15 is attached to a lower surface of the holder portion 16. The pressurizing plate 15 is attached between the pair of movement restriction portions 18, and is formed in a plate shape facing the up-down direction and extending in the front-rear direction. The pressurizing plate 15 is made of a material having a lower surface roughness than the plate holder 14, such as stainless steel.

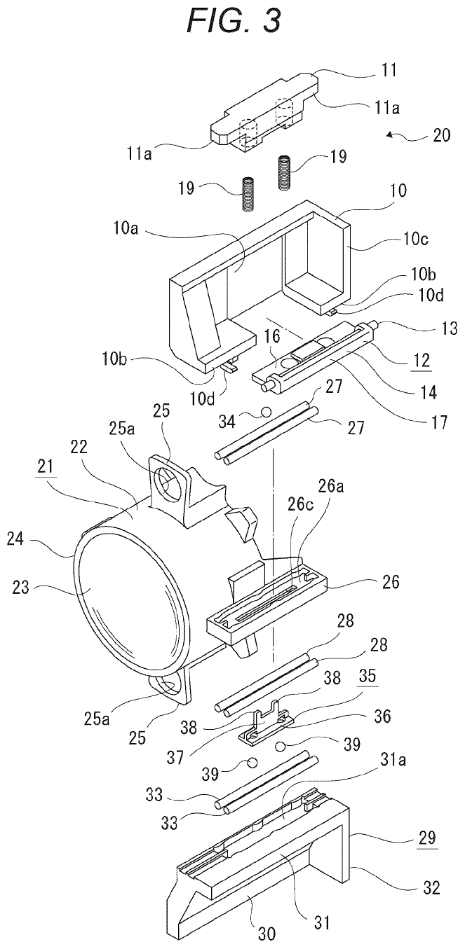

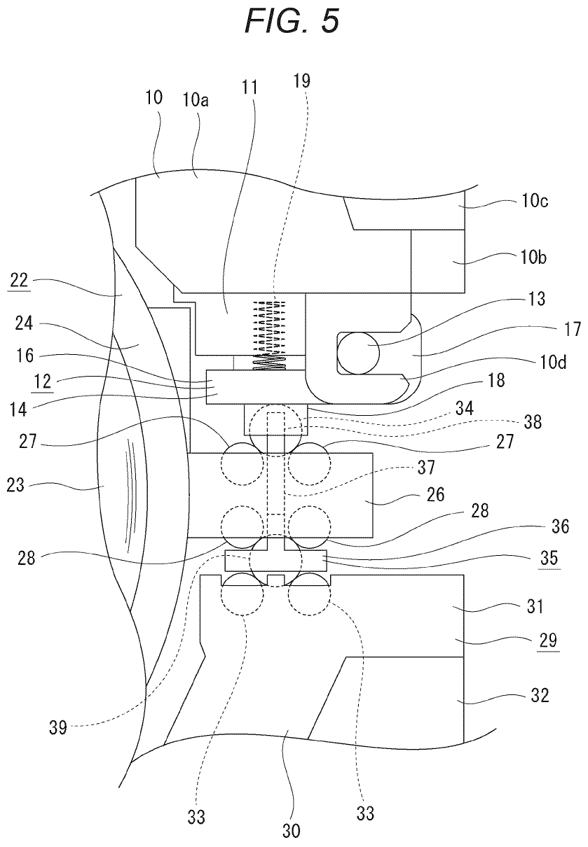

A biasing spring 19 is arranged between the spring holding base 11 and the plate holder 14 of the pressurizing base 12 (see FIGS. 3 to 5). The biasing spring 19 is, for example, a compression coil spring, and two biasing springs 19 are provided apart from each other in the front-rear direction between the pair of protruding surface portions 10b and are pressed against both front and rear end portions of the plate holder 14. Therefore, the pressurizing base 12 is biased in a direction in which the pressurizing plate 15 is moved substantially downward by the biasing force of the biasing spring 19, and a turning force in a direction in which the plate holder 14 is separated from the protruding surface portion 10b with the rotation shaft 13 as a fulcrum is applied to the pressurizing base 12.

The support frame 10, the spring holding base 11, the pressurizing base 12, the rotation shaft 13, and the biasing spring 19 constitute a biasing mechanism 20.

A moving body 21 is movable in the optical axis direction (front-rear direction) between the first fixing frame 5 and the second fixing frame 6. The moving body 21 includes a moving frame 22 having a cylindrical portion and an optical element such as a lens 23 held by the moving frame 22. Note that another element such as a diaphragm for controlling light other than the lens 23 may be used as an optical element for the moving frame 22.

The moving frame 22 includes a cylindrical holding frame portion 24, two protruding portions 25 protruding vertically from the holding frame portion 24, a bearing portion (not illustrated) protruding to one side from the holding frame portion 24, and a shaft holding portion 26 protruding to the other side from the holding frame portion 24.

A through hole 25a is formed in the protruding portion 25, and a coil of the drive source 8 is attached to a rear surface of the protruding portion 25. An iron core of the drive source 8 penetrates the through hole 25a of the protruding portion 25 and the coil attached to the protruding portion 25. Therefore, when a drive current is supplied to the coil, a driving force of the drive source 8 generates a propulsive force in the moving body 21, and the moving body 21 is moved forward or backward in the optical axis direction according to the direction of the supplied drive current.

The sub guide shaft 9 is inserted into the bearing portion protruding from the holding frame portion 24.

The shaft holding portion 26 is formed in a shape extending in the front-rear direction, and in the shaft holding portion 26, a first attachment recess 26a opened upward is formed on an upper side, and a second attachment recess 26b opened downward is formed on a lower side. In the shaft holding portion 26, an insertion hole 26c penetrating vertically is formed in a central portion in the left-right direction. The insertion hole 26c extends in the front-rear direction and communicates with the first attachment recess 26a and the second attachment recess 26b.

A pair of first guide shafts 27 are inserted into and attached to the first attachment recess 26a in the shaft holding portion 26, and the first guide shafts 27 extend in the front-rear direction and are arranged side by side in the left-right direction. A pair of second guide shafts 28 are inserted into and attached to the second attachment recess 26b in the shaft holding portion 26, and the second guide shafts 28 extend in the front-rear direction and are arranged side by side in the left-right direction.

An attachment frame 29 is attached to the front surface of the second fixing frame 6. The attachment frame 29 protrudes forward from the second fixing frame 6 and is located directly below the support frame 10. The attachment frame 29 includes a plate-shaped base portion 30 facing substantially the left-right direction, a shaft holding portion 31 protruding laterally from an upper end portion of the base portion 30, and an attached portion 32 protruding laterally from a rear end portion of the base portion 30. An upper end portion of the attached portion 32 is continuous with a rear end portion of the shaft holding portion 31. The attached portion 32 of the attachment frame 29 is attached to the second fixing frame 6.

A third attachment recess 31a opened upward is formed in the shaft holding portion 31. A pair of third guide shafts 33 are inserted into and attached to the third attachment recess 31a in the shaft holding portion 31, and the third guide shafts 33 extend in the front-rear direction and are arranged side by side in the left-right direction.

A first rolling ball 34 is arranged in a rollable state on the pair of first guide shafts 27 attached to the shaft holding portion 26 of the moving body 21. The first rolling ball 34 is in point contact with each of the pair of first guide shafts 27. The pressurizing plate 15 is pressed against the first rolling ball 34 from above by the biasing force of the biasing mechanism 20. Therefore, the first rolling ball 34 is pressed against the pair of first guide shafts 27 by the biasing force from the biasing mechanism 20, and is rolled with respect to the pressurizing plate 15 and the first guide shafts 27 along with the movement of the moving body 21 in the optical axis direction while being sandwiched between the pressurizing plate 15 and the pair of first guide shafts 27.

A retainer 35 is supported by the shaft holding portion 26 of the moving frame 22 so as to be movable in the optical axis direction. The retainer 35 is formed by integrally forming a plate-shaped ball holding portion 36 facing the up-down direction, an insertion portion 37 protruding upward from a central portion of the ball holding portion 36 in the left-right direction, and a pair of restricted portions 38 protruding upward from both front and rear end portions of the insertion portion 37. In the ball holding portion 36, two holding holes 36a having a circular shape penetrating vertically are formed to be separated in the front-rear direction.

When the insertion portion 37 is inserted into the insertion hole 26c from below, the retainer 35 is guided by the insertion hole 26c and is movable in the optical axis direction with respect to the shaft holding portion 26.

In the retainer 35, a second rolling ball 39 is rotatably inserted and held in each of the two holding holes 36a.

The second rolling ball 39 is arranged on a pair of third guide shafts 33 attached to the attachment frame 29 in a rollable state. The second rolling ball 39 is in point contact with each of the pair of third guide shafts 33. The two second rolling balls 39 are located on the front side and the rear side of the pair of restricted portions 38, and the pair of restricted portions 38 are located between the two second rolling balls 39. The first rolling ball 34 is located between the pair of restricted portions 38, and the first rolling ball 34 is movable in the optical axis direction between the pair of restricted portions 38.

The second guide shaft 28 is pressed against the second rolling ball 39 from above. The biasing force of the biasing mechanism 20 is transmitted to the second guide shaft 28 via the first rolling ball 34, the first guide shaft 27, and the shaft holding portion 26, and the second guide shaft 28 is pressed against the second rolling ball 39 by the biasing force of the biasing mechanism 20. The second rolling ball 39 is in point contact with each of the pair of second guide shafts 28.

Therefore, the second rolling ball 39 is pressed against the pair of third guide shafts 33 by the biasing force from the biasing mechanism 20, and is rolled with respect to the second guide shafts 28 and the third guide shafts 33 along with the movement of the moving body 21 in the optical axis direction while being sandwiched between the pair of second guide shafts 28 and the pair of third guide shafts 33.

As described above, in the interchangeable lens 1, the biasing force is applied from the biasing spring 19 provided in the biasing mechanism 20 to the first rolling ball 34 to press the first rolling ball 34 against the pair of first guide shafts 27, and the biasing force applied to the first rolling ball 34 is transmitted to the pair of second guide shafts 28 and the two second rolling balls 39 via the first guide shaft 27 and the like to press the second guide shafts 28 against the second rolling ball 39 and press the second rolling ball 39 against the pair of third guide shafts 33.

Therefore, the biasing force applied to the first rolling ball 34 is transmitted while being dispersed to the two second rolling balls 39 via the first guide shaft 27 and the like.

### Operation of Interchangeable Lens

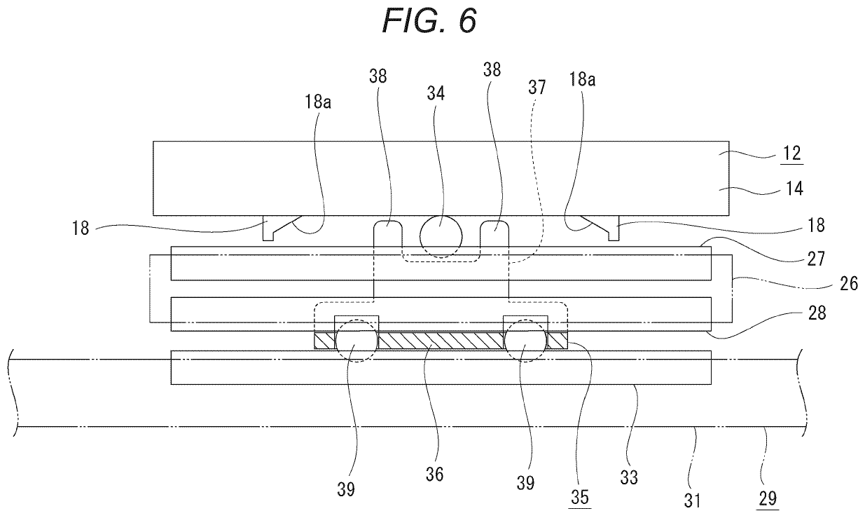

Hereinafter, the operation of the interchangeable lens 1 will be described (see FIGS. 6 to 9).

In the interchangeable lens 1, for example, a focusing operation is performed by moving the moving body 21 in the optical axis direction.

In the initial state of the focusing operation, the retainer 35 is located in a central portion of the movement range (see FIG. 6). Therefore, the retainer 35 is located corresponding to the central portion of the pressurizing base 12 in the front-rear direction. At this time, the first rolling ball 34 is held at the center between the pair of restricted portions 38 in the retainer 35.

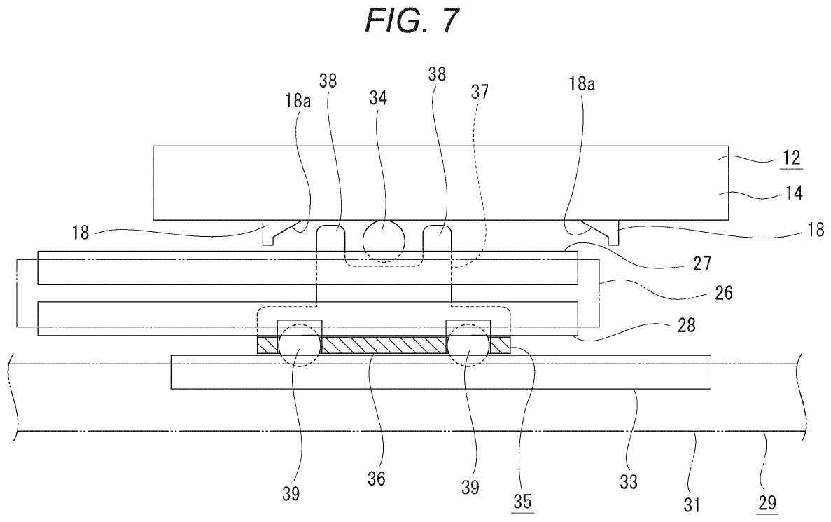

When the moving body 21 is moved in the optical axis direction by the driving force of the drive source 8, the first rolling ball 34 is rolled with respect to the first guide shaft 27, and the second rolling ball 39 is rolled with respect to the second guide shaft 28 and the third guide shaft 33 (see FIG. 7). When the moving body 21 moves in the optical axis direction, the moving body 21 is guided by the first guide shaft 27, the second guide shaft 28, and the third guide shaft 33 and guided by the sub guide shaft 9 by the rolling of the first rolling ball 34 and the second rolling ball 39.

During the movement of the moving body 21 in the optical axis direction, when the first rolling ball 34 is rotated in one direction in the optical axis direction, the second rolling ball 39 is rotated in a direction opposite to the first rolling ball 34, and when the first rolling ball 34 is rotated in the other direction in the optical axis direction, the second rolling ball 39 is rotated in a direction opposite to the first rolling ball 34.

By the first rolling ball 34 being rolled with respect to the first guide shaft 27 and the second rolling ball 39 being rolled with respect to the second guide shaft 28 and the third guide shaft 33, for example, when the moving body 21 is moved forward, the first rolling ball 34 and the second rolling ball 39 are moved forward with respect to the pressurizing base 12 and the attachment frame 29, and are moved relatively backward with respect to the shaft holding portion 26. Conversely, when the moving body 21 is moved backward, the first rolling ball 34 and the second rolling ball 39 are moved backward with respect to the pressurizing base 12 and the attachment frame 29, and are moved relatively forward with respect to the shaft holding portion 26. At this time, the retainer 35 is moved forward or backward along with the movement of the second rolling ball 39.

As described above, the first rolling ball 34 and the second rolling ball 39 are moved in the same direction as the moving body 21 with respect to the pressurizing base 12 and the attachment frame 29, and when the moving body 21 moves, the first rolling ball 34 and the second rolling ball 39 are moved in the optical axis direction with a triangular position state formed by connecting the one first rolling ball 34 and two second rolling balls 39 maintained. Therefore, a stable moving state of the moving body 21 in the optical axis direction is secured.

In a normal operation state in which a focusing operation or the like is performed in the interchangeable lens 1, the moving body 21 is moved in the optical axis direction within a range in which the restricted portion 38 of the retainer 35 does not come into contact with the movement restriction portion 18 of the pressurizing base 12.

As described above, in the interchangeable lens 1, the two second rolling balls 39 are provided, the pair of restricted portions 38 are located between the two second rolling balls 39, and the distance between the pair of restricted portions 38 is smaller than the distance between the two second rolling balls 39.

Therefore, since the first rolling ball 34 made movable between the pair of restricted portions 38 is located between the two second rolling balls 39 regardless of the position of the first rolling ball 34, the biasing force applied to the first rolling ball 34 is easily uniformly distributed and transmitted to the two second rolling balls 39, and a stable moving state of the moving body 21 can be secured.

In addition, the retainer 35 is provided with the ball holding portion 36 that holds the second rolling ball 39, the shaft holding portion 26 is formed with the insertion hole 26c extending in the optical axis direction, a part of the retainer 35 is inserted into the insertion hole 26c, and the pair of restricted portions 38 and the ball holding portion 36 are located on opposite sides with the insertion hole 26c interposed therebetween.

Therefore, since the first rolling ball 34 located between the pair of restricted portions 38 and the second rolling ball 39 held by the ball holding portion 36 are located on opposite sides of the shaft holding portion 26, arrangement spaces of the first rolling ball 34 and the second rolling ball 39 are close to each other, and the interchangeable lens 1 can be downsized.

Furthermore, since the two biasing springs 19 are provided separately in the optical axis direction, the direction and magnitude of the biasing force applied to the first rolling ball 34 hardly change regardless of the position of the first rolling ball 34, and a stable moving state of the moving body 21 can be secured in the entire moving range of the moving body 21.

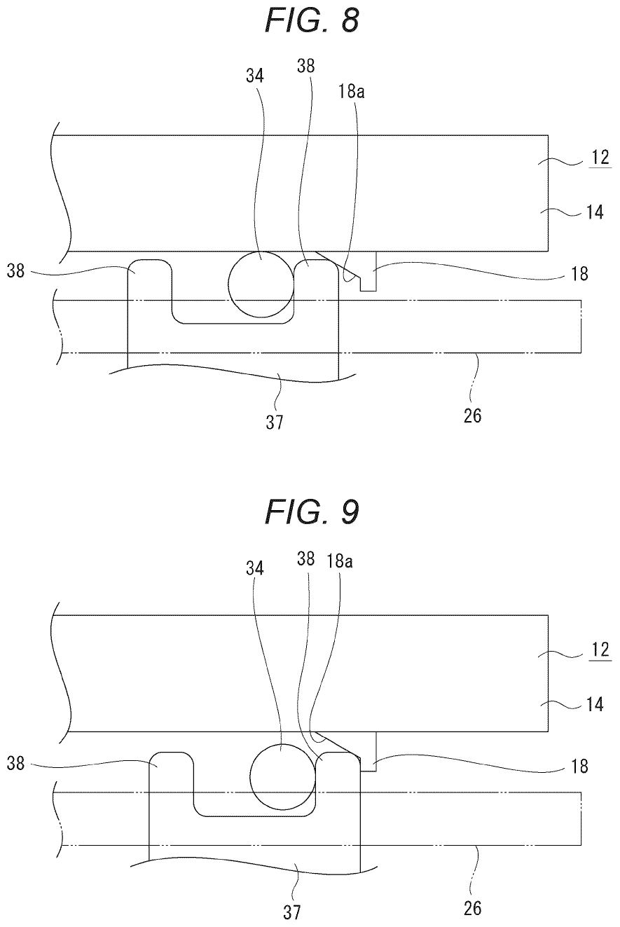

In the interchangeable lens 1, for example, when the imaging device 100 falls or a large impact is applied to the imaging device 100, the retainer 35 and the first rolling ball 34 may be unintentionally moved in the optical axis direction (see FIG. 8). When the retainer 35 and the first rolling ball 34 are moved in the optical axis direction, the movement of the retainer 35 in the optical axis direction is restricted by the restricted portion 38 coming into contact with the movement restriction portion 18 of the pressurizing base 12. At this time, when the first rolling ball 34 is in contact with the restricted portion 38, the static frictional force with respect to the first rolling ball 34 increases, and it may be difficult to move the moving body 21 in the optical axis direction depending on the magnitude of the driving force of the drive source 8.

Therefore, it is possible to move the moving body 21 in the optical axis direction by increasing the driving force of the drive source 8, but when the driving force of the drive source 8 is increased, it is necessary to increase the drive source 8 accordingly, and thus the size of the interchangeable lens 1 and the manufacturing cost increase.

Therefore, in the interchangeable lens 1, in order to ensure a smooth moving state of the moving body 21, the following reset operation of moving the retainer 35 to the center in the moving range is performed.

In the reset operation, the moving body 21 is moved in the optical axis direction in a range exceeding the normal movement range such as a focusing operation. That is, when the reset operation is started, the moving body 21 is moved to a position where the movement restriction portion 18 of the pressurizing base 12 is pressed by the restricted portion 38 of the retainer 35.

The retainer 35 is moved along with the movement of the moving body 21, and the movement restriction portion 18 is pressed by the restricted portion 38. When the movement restriction portion 18 is pressed by the restricted portion 38, the restricted portion 38 slides on the inclined surface 18a formed in the movement restriction portion 18. Therefore, the pressurizing base 12 is pushed up against the biasing force of the biasing spring 19 by the movement of the retainer 35.

When the pressurizing base 12 is pushed up, the biasing force applied from the biasing spring 19 to the first rolling ball 34 is reduced, and the frictional force of the first rolling ball 34 with respect to the first guide shaft 27 is reduced. When the frictional force of the first rolling ball 34 with respect to the first guide shaft 27 is reduced, the first rolling ball 34 is easily rotated, and the moving body 21 can be moved without increasing the driving force of the drive source 8.

In addition, even when the first rolling ball 34 is in contact with the restricted portion 38, the biasing force applied from the biasing spring 19 to the first rolling ball 34 is reduced, so that the first rolling ball 34 can be separated from the restricted portion 38.

When the movement restriction portion 18 is pressed by the restricted portion 38 to push up the pressurizing base 12, a driving force for moving the moving body 21 in a direction opposite to the above-mentioned direction is applied from the drive source 8, and the moving body 21 is moved toward the center in the moving range. When the moving body 21 is moved toward the center in the movement range, the pressing of the movement restriction portion 18 by the restricted portion 38 is released, the pressurizing base 12 is pushed down to the original position by the biasing force of the biasing spring 19, and the biasing force of the original size is applied from the biasing mechanism 20 to the first rolling ball 34. Therefore, the first rolling ball 34 is brought into a state of being able to roll with respect to the first guide shaft 27 in a stable state along with the movement of the moving body 21 in the optical axis direction.

The moving body 21 is moved to the center in the moving range, and the retainer 35 is also held at the center in the moving range, and the reset operation is completed.

Note that the above-described reset operation may be performed, for example, when a state in which the restricted portion 38 is in contact with the movement restriction portion 18 is detected, or may be performed each time the power button is operated and the power of the imaging device 100 is turned on.

In a case where the reset operation is performed each time the power is turned on, it is not necessary to detect the positions of the retainer 35 and the first rolling ball 34 in the optical axis direction, and the manufacturing cost of the interchangeable lens 1 and the imaging device 100 can be reduced. In addition, since the retainer 35 is always held at the center in the movement range at the start of imaging, the moving body 21 can be smoothly and reliably moved at the start of imaging.

Furthermore, in the above description, an example has been described in which the inclined surface 18a of the movement restriction portion 18 is pressed by the restricted portion 38 of the retainer 35 and the reset operation is started. However, an inclined surface may be formed on the restricted portion instead of the inclined surface 18a of the movement restriction portion 18, and the movement restriction portion may be pressed by the inclined surface of the restricted portion to start the reset operation.

### Summary

As described above, in the interchangeable lens 1 and the imaging device 100, one first rolling ball 34 that rolls with respect to the first guide shaft 27 when the moving body 21 moves in the optical axis direction, and a plurality of, such as two, second rolling balls 39 that are located separately from each other in the optical axis direction and roll with respect to the second guide shaft 28 and the third guide shaft 33 when the moving body 21 moves in the optical axis direction are provided, and the biasing force of the biasing mechanism 20 with respect to the first rolling ball 34 is applied while being dispersed to the plurality of second rolling balls 39 via the second guide shaft 28.

Therefore, the first rolling ball 34 is pressed against the first guide shaft 27 by the biasing force of the biasing mechanism 20 and the second guide shaft 28 is pressed against the second rolling ball 39, and the dispersed biasing force is applied to the plurality of second rolling balls 39.

On the other hand, for example, in a case where a plurality of first rolling balls 34 is provided, there is a possibility that a difference occurs in the biasing force applied to each of the first rolling balls 34 depending on the movement position of the moving body 21, and a difference may also occur in the biasing force transmitted to each of the second rolling balls 39.

Therefore, as described above, the biasing force is applied to one first rolling ball 34, and the biasing force applied to the first rolling ball 34 is transmitted to the plurality of second rolling balls 39, so that a difference hardly occurs in the biasing force transmitted to each of the second rolling balls 39, and a stable operation state of the moving body 21 can be secured.

Furthermore, when the moving body 21 moves in the optical axis direction, the first rolling ball 34 is rolled with respect to the first guide shaft 27, and the second rolling ball 39 is rolled with respect to the second guide shaft 28 and the third guide shaft 33. Therefore, there is no minute clearance between the bearing portion of the moving body and the guide shaft in which the bearing portion is guided by the guide shaft, and it is possible to improve the stop position accuracy of the moving body 21 and to prevent the occurrence of inclination of the moving body 21 in the tilt direction.

Furthermore, in addition to reducing the occurrence of abnormal noise due to sliding that occurs in a configuration in which the bearing portion is guided by the guide shaft, the stop position accuracy of the moving body 21 can be improved, and the occurrence of inclination in the tilt direction of the moving body 21 can be prevented. Therefore, high focusing accuracy can be secured even with respect to an increase in the number of pixels and an increase in the frame rate of the imaging element.

Furthermore, since the stop position accuracy of the moving body 21 can be improved and the occurrence of the inclination in the tilt direction of the moving body 21 can be prevented, the moving stroke of the moving body 21 can be lengthened and the functionality can be improved by securing the stable operation state of the moving body 21.

In addition, although there is a possibility that the moving body 21 in which the center of gravity is shifted to the front side or the rear side may be used depending on the position, shape, and the like of the internal structure of the moving body 21, even in a case where such a moving body 21 is used, it is possible to improve the stop position accuracy of the moving body 21 and to prevent the occurrence of the inclination in the tilt direction of the moving body 21.

Therefore, even in a case where the moving body 21 in which the center of gravity is shifted to the front side or the rear side is used, it is possible to suppress vibration at the time of movement by securing stability of movement control, and thus, it is possible to improve the degree of freedom in design and achieve miniaturization by improving the degree of freedom in design.

In addition, the retainer 35 that has the restricted portion 38, holds the second rolling ball 39 in a rotatable state, and is moved in the optical axis direction with the rolling of the second rolling ball 39 is provided, and the movement restriction portion 18 is pressed in the optical axis direction by the restricted portion 38, so that the biasing force of the biasing mechanism 20 to the first rolling ball 34 is reduced.

Therefore, since the frictional force of the first rolling ball 34 with respect to the first guide shaft 27 is reduced by reducing the biasing force of the biasing mechanism 20 with respect to the first rolling ball 34, it is possible to reduce the driving force for moving the moving body 21 and move the retainer 35 to a predetermined position by the reset operation.

Furthermore, pairs of the movement restriction portion 18 and the restricted portion 38 are provided separately from each other in the optical axis direction, and the first rolling ball 34 is movable between the pair of restricted portions 38.

Therefore, since the first rolling ball 34 is made movable in the optical axis direction within a certain range, the movement amount of the first rolling ball 34 in the optical axis direction can be made larger than the movement amount of the second rolling ball 39 in the optical axis direction, and the movement stroke of the moving body 21 can be expanded.

Furthermore, the biasing mechanism 20 is provided with the biasing spring 19 and the pressurizing base 12, the biasing force of the biasing spring 19 is transmitted to the first rolling ball 34 via the pressurizing base 12, and the pressurizing base 12 is provided with the movement restriction portion 18.

Therefore, since the pressurizing base 12 having the movement restriction portion 18 is pressed against the first rolling ball 34 and the biasing force of the biasing spring 19 is applied to the first rolling ball 34, the configuration of the biasing mechanism 20 is simple, and the stable moving state of the moving body 21 can be secured while simplifying the mechanism.

In addition, the pressurizing base 12 is made rotatable in a direction of separating from the first rolling ball 34, the inclined surface 18a is formed in the movement restriction portion 18, and the inclined surface 18a is pressed by the restricted portion 38, whereby the pressurizing base 12 is rotated in a direction of separating from the first rolling ball 34.

Therefore, when the inclined surface 18a is pressed by the restricted portion 38, the pressurizing base 12 is rotated, and the biasing force of the biasing spring 19 with respect to the first rolling ball 34 is reduced. Therefore, it is possible to reduce the driving force for moving the moving body 21 by a simple operation with a simple configuration, and it is possible to move the retainer 35 to a predetermined position by the reset operation without increasing the manufacturing cost.

### One Embodiment of Imaging Device

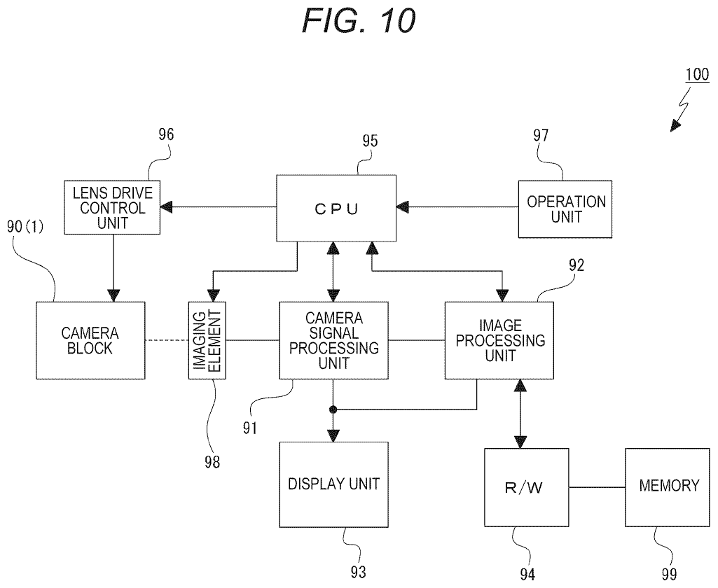

Hereinafter, an example configuration of one embodiment of the imaging device of the present technology will be described (see FIG. 10).

An imaging device 100 is equipped with a camera block 90 having an imaging function, and includes: a camera signal processing unit 91 that performs signal processing such as analog-digital conversion of a captured image signal; and an image processing unit 92 that performs a recording/reproducing processing on the image signal. Also, the imaging device 100 includes: a display unit (display) 93 that displays a captured image and the like; a reader/writer (R/W) 94 that writes and reads an image signal into and from a memory 99; a central processing unit (CPU) 95 that controls the entire imaging device 100; a lens drive control unit 96 that controls driving of the lens arranged in the camera block 90; and an operation unit 97 (202) such as various switches on which a user performs required operations.

The camera block 90 is, for example, the interchangeable lens 1.

The imaging device 100 is provided with an imaging element 98 such as a CCD or a CMOS that converts an optical image captured by the camera block 90 into an electrical signal.

The camera signal processing unit 91 performs various kinds of signal processing such as conversion of an output signal from the imaging element 98 into a digital signal, noise removal, image quality correction, and conversion into a luminance/color difference signal.

The image processing unit 92 performs compression encoding/decompression decoding processing on an image signal based on a predetermined image data format, conversion processing on data specification such as resolution, and the like.

The display unit 93 has a function of displaying various kinds of data such as an operating state of the user on the operation unit 97 and a captured image. Note that the imaging device 100 may omit the display unit 93, and may be designed so that captured image data is sent to another display device to be displayed.

The R/W 94 writes image data encoded by the image processing unit 92 into the memory 99, and reads image data recorded in the memory 99.

The CPU 95 serves as a control processing unit that controls each circuit block provided in the imaging device 100, and controls each circuit block on the basis of an instruction input signal or the like from the operation unit 97.

The lens drive control unit 96 controls a drive source that moves the lens on the basis of a control signal from the CPU 95.

The operation unit 97 outputs an instruction input signal in accordance with a user operation, to the CPU 95.

The memory 99 is a semiconductor memory attachable to and detachable from a slot connected to the R/W 94, or a semiconductor memory incorporated beforehand into the imaging device 100, for example.

Hereinafter, an operation of the imaging device 100 will be described.

In a standby state for imaging, under the control of the CPU 95, a captured image signal is output to the display unit 93 via the camera signal processing unit 91, and is displayed as a through-the-camera image. Furthermore, when an instruction input signal from the operation unit 97 is input, the CPU 95 outputs a control signal to the lens drive control unit 96, and the lens is moved on the basis of control performed by the lens drive control unit 96.

When an imaging operation is performed in accordance with the instruction input signal from the operation unit 97, a captured image signal is output from the camera signal processing unit 91 to the image processing unit 92, is subjected to compression encoding processing, and is converted into digital data in a predetermined data format. The converted data is output to the R/W 94, and is written into the memory 99.

In a case where the image data recorded in the memory 99 is reproduced, predetermined image data is read from the memory 99 by the R/W 94 in response to an operation performed on the operation unit 97, and decompression decoding processing is performed by the image processing unit 92. After that, a reproduced image signal is output to the display unit 93, and a reproduced image is displayed.

Note that in the present technology, the term “imaging” refers to processing including only some of or all of a series of processing starting from photoelectric conversion processing of converting captured light into an electrical signal by the imaging element 98, processing such as conversion of the output signal from the imaging element 98 into a digital signal, noise removal, image quality correction, and conversion into a luminance/color difference signal by the camera signal processing unit 91, compression encoding/decompression decoding processing for an image signal based on a predetermined image data format, and processing of converting the data specification such as the resolution by the image processing unit 92, till processing of writing the image signal into the memory 99 by the R/W 94.

That is, “imaging” may refer to only photoelectric conversion processing of converting light captured by the imaging element 98 into an electrical signal, may refer to processing from photoelectric conversion processing of converting light captured by the imaging element 98 into an electrical signal to processing such as conversion of an output signal from the imaging element 98 into a digital signal, noise removal, image quality correction, conversion into a luminance and chrominance signal, or the like to be performed by the camera signal processing unit 91, may refer to processing from photoelectric conversion processing of converting light captured by the imaging element 98 into an electrical signal to compression encoding and decompression decoding processing for an image signal based on a predetermined image data format by the image processing unit 92 or processing of converting a data specification such as resolution via processing such as conversion of an output signal from the imaging element 98 into a digital signal, noise removal, image quality correction, conversion into a luminance/color difference signal, or the like by the camera signal processing unit 91, may refer to processing from photoelectric conversion processing of converting light captured by the imaging element 98 into an electrical signal to processing such as conversion of an output signal from the imaging element 98 into a digital signal, noise removal, image quality correction, conversion into a luminance and chrominance signal, or the like by the camera signal processing unit 91, compression encoding and decompression decoding processing for an image signal based on a predetermined image data format by the image processing unit 92, or processing of converting a data specification such as resolution, or may refer to processing to be performed by the R/W 94 to write an image signal into the memory 99.

In the above-described processing, the order of the processing may be changed as appropriate.

Furthermore, in the present technology, the camera block 90 and the imaging device 100 may include only some of or all of the imaging element 98, the camera signal processing unit 91, the image processing unit 92, and the R/W 94 that perform the above-described processing.

Moreover, the camera block 90 may include some of the imaging element 98, the camera signal processing unit 91, the image processing unit 92, and the R/W 94.

### Present Technology

The present technology may also be configured as described below.
(1)

An interchangeable lens including:
a moving body including a moving frame provided with a shaft holding portion and an optical element held by the moving frame, the moving body being moved in an optical axis direction;
a drive source that applies a drive force to the moving body;
a pair of first guide shafts that are held by the shaft holding portion, have an axial direction coinciding with the optical axis direction, and are arranged in a direction orthogonal to the optical axis direction;
one first rolling ball that is rolled with respect to the pair of first guide shafts when the moving body moves in the optical axis direction;
a pair of second guide shafts that are held by the shaft holding portion, have an axial direction coinciding with the optical axis direction, and are arranged in a direction orthogonal to the optical axis direction;
a pair of third guide shafts that are located on the opposite side of the first guide shaft with the second guide shaft interposed therebetween, have an axial direction coinciding with the optical axis direction, and are arranged in a direction orthogonal to the optical axis direction;
a plurality of second rolling balls located separately in the optical axis direction and rolled with respect to the pair of second guide shafts and the pair of third guide shafts when the moving body moves in the optical axis direction; and
a biasing mechanism that biases the first rolling ball in a direction of pressing the first rolling ball against the first guide shaft, in which
a biasing force applied to the first rolling ball by the biasing mechanism is distributed to the plurality of second rolling balls via the first guide shaft and the second guide shaft.
(2)

The interchangeable lens according to (1), in which:
the biasing mechanism includes a movement restriction portion that is immovable in the optical axis direction and is located separately in the optical axis direction;
the interchangeable lens further includes a retainer that has a restricted portion, holds the second rolling ball in a rotatable state, and is moved in the optical axis direction along with rolling of the second rolling ball; and
the movement restriction portion is pressed in the optical axis direction by the restricted portion, so that the biasing force of the biasing mechanism against the first rolling ball is reduced.
(3)

The interchangeable lens according to (2), in which
pairs of the movement restriction portion and the restricted portion are provided to be separated from each other in the optical axis direction, and
the first rolling ball is movable between the pair of restricted portions.
(4)

The interchangeable lens according to (3), in which:
two second rolling balls are provided;
the pair of restricted portions are located between the two second rolling balls; and
a distance between the pair of restricted portions is made smaller than a distance between the two second rolling balls.
(5)

The interchangeable lens according to (3) or (4), in which:
the retainer is provided with a ball holding portion that holds the second rolling ball in a rotatable state;
an insertion hole extending in the optical axis direction is formed in the shaft holding portion; and
a part of the retainer is inserted into the insertion hole, and the pair of restricted portions and the ball holding portion are located on opposite sides with the insertion hole interposed therebetween.
(6)

The interchangeable lens according to any one of (2) to (5), in which:
the biasing mechanism is provided with a biasing spring and a pressurizing base;
a biasing force of the biasing spring is transmitted to the first rolling ball via the pressurizing base; and
the movement restriction portion is provided in the pressurizing base.
(7)

The interchangeable lens according to (6), in which:
the pressurizing base is rotatable in a direction separating from the first rolling ball;
an inclined surface is formed in the movement restriction portion; and
the inclined surface is pressed by the restricted portion to rotate the pressurizing base in a direction separating from the first rolling ball.
(8)

The interchangeable lens according to (6) or (7), in which
two biasing springs are provided to be separated from each other in the optical axis direction.
(9)

An imaging device including:
a device main body including an imaging element that converts a captured optical image into an electrical signal;
an interchangeable lens detachably attached to the device main body;
a moving body including a moving frame provided with a shaft holding portion and an optical element held by the moving frame, the moving body being moved in an optical axis direction;
a drive source that applies a drive force to the moving body;
a pair of first guide shafts that are held by the shaft holding portion, have an axial direction coinciding with the optical axis direction, and are arranged in a direction orthogonal to the optical axis direction;
one first rolling ball that is rolled with respect to the pair of first guide shafts when the moving body moves in the optical axis direction;
a pair of second guide shafts that are held by the shaft holding portion, have an axial direction coinciding with the optical axis direction, and are arranged in a direction orthogonal to the optical axis direction;
a pair of third guide shafts that are located on the opposite side of the first guide shaft with the second guide shaft interposed therebetween, have an axial direction coinciding with the optical axis direction, and are arranged in a direction orthogonal to the optical axis direction;
a plurality of second rolling balls located separately in the optical axis direction and rolled with respect to the pair of second guide shafts and the pair of third guide shafts when the moving body moves in the optical axis direction; and
a biasing mechanism that biases the first rolling ball in a direction of pressing the first rolling ball against the first guide shaft, in which
a biasing force applied to the first rolling ball by the biasing mechanism is distributed to the plurality of second rolling balls via the first guide shaft and the second guide shaft.

### REFERENCE SIGNS LIST

100 Imaging device
1 Interchangeable lens
8 Drive source
12 Pressurizing base
18 Movement restriction portion
18a Inclined surface
19 Biasing spring
20 Biasing mechanism
21 Moving body
22 Moving frame
23 Lens
26 Shaft holding portion
26c Insertion hole
27 First guide shaft
28 Second guide shaft
33 Third guide shaft
34 First rolling ball
35 Retainer
36 Ball holding portion
38 Restricted portion
39 Second rolling ball
98 Imaging element

1. An interchangeable lens comprising:
a moving body including a moving frame provided with a shaft holding portion and an optical element held by the moving frame, the moving body being moved in an optical axis direction;
a drive source that applies a drive force to the moving body;
a pair of first guide shafts that are held by the shaft holding portion, have an axial direction coinciding with the optical axis direction, and are arranged in a direction orthogonal to the optical axis direction;
one first rolling ball that is rolled with respect to the pair of first guide shafts when the moving body moves in the optical axis direction;
a pair of second guide shafts that are held by the shaft holding portion, have an axial direction coinciding with the optical axis direction, and are arranged in a direction orthogonal to the optical axis direction;
a pair of third guide shafts that are located on the opposite side of the first guide shaft with the second guide shaft interposed therebetween, have an axial direction coinciding with the optical axis direction, and are arranged in a direction orthogonal to the optical axis direction;
a plurality of second rolling balls located separately in the optical axis direction and rolled with respect to the pair of second guide shafts and the pair of third guide shafts when the moving body moves in the optical axis direction; and
a biasing mechanism that biases the first rolling ball in a direction of pressing the first rolling ball against the first guide shaft, wherein
a biasing force applied to the first rolling ball by the biasing mechanism is distributed to the plurality of second rolling balls via the first guide shaft and the second guide shaft.

2. The interchangeable lens according to claim 1, wherein:
the biasing mechanism includes a movement restriction portion that is immovable in the optical axis direction and is located separately in the optical axis direction;
the interchangeable lens further includes a retainer that has a restricted portion, holds the second rolling ball in a rotatable state, and is moved in the optical axis direction along with rolling of the second rolling ball; and
the movement restriction portion is pressed in the optical axis direction by the restricted portion, so that the biasing force of the biasing mechanism against the first rolling ball is reduced.

3. The interchangeable lens according to claim 2, wherein
pairs of the movement restriction portion and the restricted portion are provided to be separated from each other in the optical axis direction, and
the first rolling ball is movable between the pair of restricted portions.

4. The interchangeable lens according to claim 3, wherein:
two second rolling balls are provided;
the pair of restricted portions are located between the two second rolling balls; and
a distance between the pair of restricted portions is made smaller than a distance between the two second rolling balls.

5. The interchangeable lens according to claim 3, wherein:
the retainer is provided with a ball holding portion that holds the second rolling ball in a rotatable state;
an insertion hole extending in the optical axis direction is formed in the shaft holding portion; and
a part of the retainer is inserted into the insertion hole, and the pair of restricted portions and the ball holding portion are located on opposite sides with the insertion hole interposed therebetween.

6. The interchangeable lens according to claim 2, wherein:
the biasing mechanism is provided with a biasing spring and a pressurizing base;
a biasing force of the biasing spring is transmitted to the first rolling ball via the pressurizing base; and
the movement restriction portion is provided in the pressurizing base.

7. The interchangeable lens according to claim 6, wherein:
the pressurizing base is rotatable in a direction separating from the first rolling ball;
an inclined surface is formed in the movement restriction portion; and
the inclined surface is pressed by the restricted portion to rotate the pressurizing base in a direction separating from the first rolling ball.

8. The interchangeable lens according to claim 6, wherein
two biasing springs are provided to be separated from each other in the optical axis direction.

9. An imaging device comprising:
a device main body including an imaging element that converts a captured optical image into an electrical signal;
an interchangeable lens detachably attached to the device main body;
a moving body including a moving frame provided with a shaft holding portion and an optical element held by the moving frame, the moving body being moved in an optical axis direction;
a drive source that applies a drive force to the moving body;
a pair of first guide shafts that are held by the shaft holding portion, have an axial direction coinciding with the optical axis direction, and are arranged in a direction orthogonal to the optical axis direction;
one first rolling ball that is rolled with respect to the pair of first guide shafts when the moving body moves in the optical axis direction;
a pair of second guide shafts that are held by the shaft holding portion, have an axial direction coinciding with the optical axis direction, and are arranged in a direction orthogonal to the optical axis direction;
a pair of third guide shafts that are located on the opposite side of the first guide shaft with the second guide shaft interposed therebetween, have an axial direction coinciding with the optical axis direction, and are arranged in a direction orthogonal to the optical axis direction;
a plurality of second rolling balls located separately in the optical axis direction and rolled with respect to the pair of second guide shafts and the pair of third guide shafts when the moving body moves in the optical axis direction; and
a biasing mechanism that biases the first rolling ball in a direction of pressing the first rolling ball against the first guide shaft, wherein
a biasing force applied to the first rolling ball by the biasing mechanism is distributed to the plurality of second rolling balls via the first guide shaft and the second guide shaft.
